(19) United States
(12) Patent Application Publication
(10) Pub. No.: US 2026/0101219 A1
(43) Pub. Date: Apr. 9, 2026

(54) EVENT-DRIVEN BEAM REPORTING FOR LAYER 1 (L1) / LAYER 2 (L2) TRIGGERED MOBILITY (LTM)

(71) Applicant: QUALCOMM Incorporated, San Diego, CA (US)

(72) Inventors: Doohyun SUNG, Basking Ridge, NJ (US); Naeem AKL, San Jose, CA (US); Wooseok NAM, San Diego, CA (US); Jelena DAMNJANOVIC, Del Mar, CA (US)

(21) Appl. No.: 19/323,947

(22) Filed: Sep. 9, 2025

Related U.S. Application Data
(60) Provisional application No. 63/702,946, filed on Oct. 3, 2024.

(51) Int. Cl. H04W 24/10; H04B 7/06; H04W 72/21

(52) U.S. Cl. CPC H04W 24/10; H04B 7/06958; H04W 72/21

(57) ABSTRACT

A method for wireless communication at a user equipment (UE) includes receiving one or more first reference signals (RSs) on one or more beams associated with one or more of a serving cell or one or more candidate cells. The method also includes initiating a time to trigger (TTT) timer in accordance with one or more first channel characteristics of the one or more beams satisfying a first event condition of a group of event conditions in accordance with measuring the one or more first RSs. The method further includes receiving one or more second RSs on the one or more beams. The method still further includes transmitting a first layer 1/layer 2 triggered measurement (LTM) beam report in accordance with determining one or more second channel characteristics of the one or more beams satisfying a second event condition based on measuring the one or more second RSs.

### CROSS-REFERENCE TO RELATED APPLICATION

The present application claims the benefit of U.S. Provisional Ser. No. 63/702,946 , filed on Oct. 3, 2024, and titled “EVENT-DRIVEN BEAM REPORTING FOR LAYER TRIGGERED MOBILITY (LTM),” the disclosure of which is expressly incorporated by reference in its entirety.

### FIELD OF THE DISCLOSURE

The present disclosure relates generally to wireless communications, and more specifically to user equipment (UE)-initiated, event-driven beam reporting for layer 1 (L1)/layer 2 (L2) triggered mobility (LTM).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In one aspect of the present disclosure, a method for wireless communication at a user equipment (UE) includes receiving one or more first reference signals (RSs) on one or more beams associated with one or more of a serving cell or one or more candidate cells. The method further includes initiating a time to trigger (TTT) timer in accordance with one or more first channel characteristics of the one or more beams satisfying a first event condition, in accordance with measuring the one or more first RSs, with each event condition associated with one or more of an entering condition or a leaving condition. The method still further includes receiving one or more second RSs on the one or more beams. The method also includes transmitting a first layer 1 (L1)/layer 2 (L2) triggered measurement (LTM) beam report in accordance with determining one or more second channel characteristics of the one or more beams satisfying a second event condition based on the measurements of the second RSs.

Another aspect of the present disclosure is directed to an apparatus including means for receiving one or more first reference signals (RSs) on one or more beams associated with one or more of a serving cell or one or more candidate cells. The apparatus further includes means for initiating a time to trigger (TTT) timer in accordance with one or more first channel characteristics of the one or more beams satisfying a first event condition based on measuring the one or more first RSs, each event condition associated with an entering condition or a leaving condition. The apparatus still further includes means for receiving one or more second RSs on the one or more beams. The apparatus also includes means for transmitting a first layer 1 (L1)/layer 2 (L2) triggered measurement (LTM) beam report based on determining one or more second channel characteristics of the one or more beams satisfying a second event condition in accordance with the measurement of the second RSs.

In another aspect of the present disclosure, a non-transitory computer-readable medium with non-transitory program code recorded thereon is disclosed. The program code is executed by a processor and includes program code to receive one or more first reference signals (RSs) on one or more beams associated with one or more of a serving cell or one or more candidate cells. The program code further includes program code to initiate a time to trigger (TTT) timer in accordance with one or more first channel characteristics of the one or more beams satisfying a first event condition, based on measuring the one or more first RSs, where each event condition is associated with one or more of an entering condition or a leaving condition. The program code still further includes program code to receive one or more second RSs on the one or more beams. The program code also includes program code to transmit a first LTM beam report based on determining one or more second channel characteristics of the one or more beams satisfying a second event condition in accordance with the measurement of the second RSs.

Another aspect of the present disclosure is directed to an apparatus for wireless communication at a user equipment (UE). The apparatus includes a processor, and a memory coupled with the processor and storing instructions operable, when executed by the processor, to cause the apparatus to receive one or more first reference signals (RSs) on one or more beams associated with one or more of a serving cell or one or more candidate cells. Execution of the instructions further cause the apparatus to initiate a time to trigger (TTT) timer in accordance with one or more first channel characteristics of the one or more beams satisfying a first event condition in accordance with measuring the one or more first RSs, where each event condition is associated with one or more of an entering condition or a leaving condition. Execution of the instructions still further cause the apparatus to receive one or more second RSs on the one or more beams. Execution of the instructions also cause the apparatus to transmit a first LTM beam report based on determining one or more second channel characteristics of the one or more beams satisfying a second event condition based on measuring the second RSs.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 illustrates an example of a layer 1 (L1)/layer 2 (L2) triggered mobility (LTM)-channel state information (CSI)-synchronization signal block (SSB)-ResourceSet-r18 information element (IE), in accordance with various aspects of the present disclosure.

FIG. 5 illustrates an example of a graph for a layer 3 (L3) measurement report (MR) event A3, in accordance with various aspects of the present disclosure.

FIG. 6A is a table illustrating an example of per-beam and per-cell measurement evaluations for a layer 1 (L1) reference signal received power (L1-RSRP), in accordance with various aspects of the present disclosure.

FIG. 6B is a table illustrating an example of per-beam pair and per-cell pair measurement evaluations for L1-RSRP, in accordance with various aspects of the present disclosure.

FIG. 6C is a table illustrating an example of per-beam pair and per-cell pair measurement evaluations for L1-RSRP, in accordance with various aspects of the present disclosure.

FIG. 7A is a diagram illustrating an example of an event condition triggering a beam report event, in accordance with various aspects of the present disclosure.

FIG. 7B is a diagram illustrating an example of event condition triggering a beam report event, in accordance with various aspects of the present disclosure.

FIG. 8 is a flow diagram illustrating an example process performed, for example, by a user equipment (UE), in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

In some wireless communication systems, beam reporting may be improved by using a user equipment (UE)-initiated/event-driven mechanism that enables transmission of timely beam reports to a network node (e.g., gNB or base station) with reduced overhead. In such systems, beam management may be improved by reducing a frequency of beam reporting and lowering latency.

Various aspects of layer 3 (L3) event-triggered measurement reports, such as hysteresis (HYS), time-to-trigger (TTT), and entering/leaving conditions, are adopted for layer 1 (L1)/layer 2 (L2) triggered measurement (LTM) event-triggered layer 1 (L1) measurement reports. There are, however, certain differences that must be addressed between L1 measurement reports and L3 measurement reports. In L3,measurement reports are evaluated using a cell-level metric, whereas LTM event-triggered L1 reports are based on a more granular beam-level metric. Accordingly, the entering/leaving conditions and TTT management need to be adapted for individual beams.

Moreover, the media access control (MAC)-control element (CE) format may be specified to support different types of events specific to LTM. Various aspects of this disclosure focus on developing event evaluation methods to manage entering/leaving conditions and TTT for LTM, specifically for UE-initiated or event-driven L1 measurement reporting. This ensures that the reporting mechanisms respond to beam-level changes in the network.

Particular aspects of the subject matter described in this disclosure can be implemented to realize one or more of the following potential advantages. In some examples, the described techniques, such as configuring the UE for per-beam or per-beam pair evaluations, may improve the accuracy and responsiveness of event-triggered measurement reporting, allowing more precise beam management.

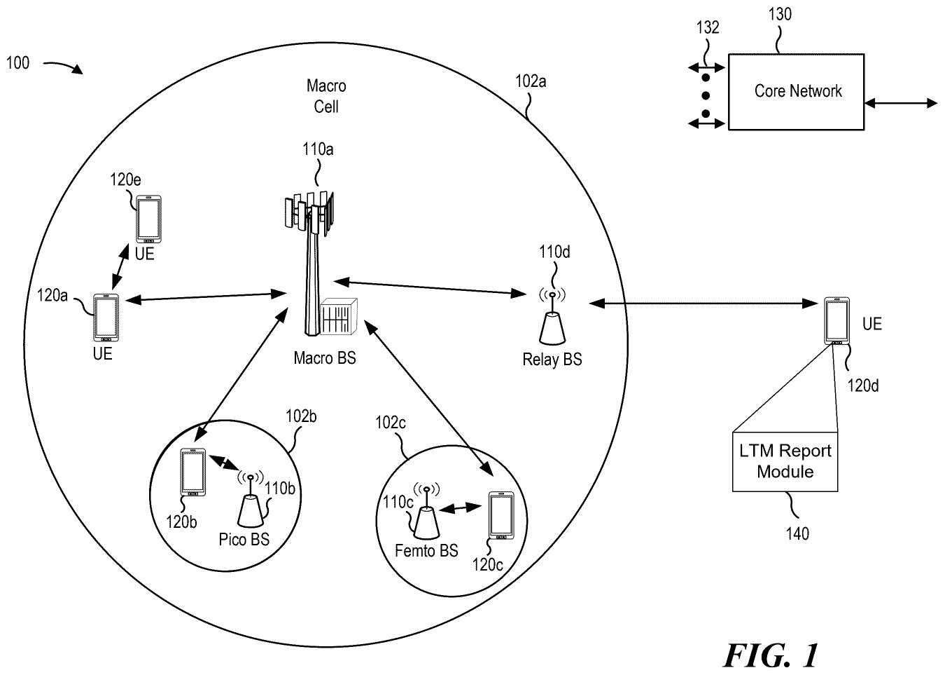

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,”and “cell”may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

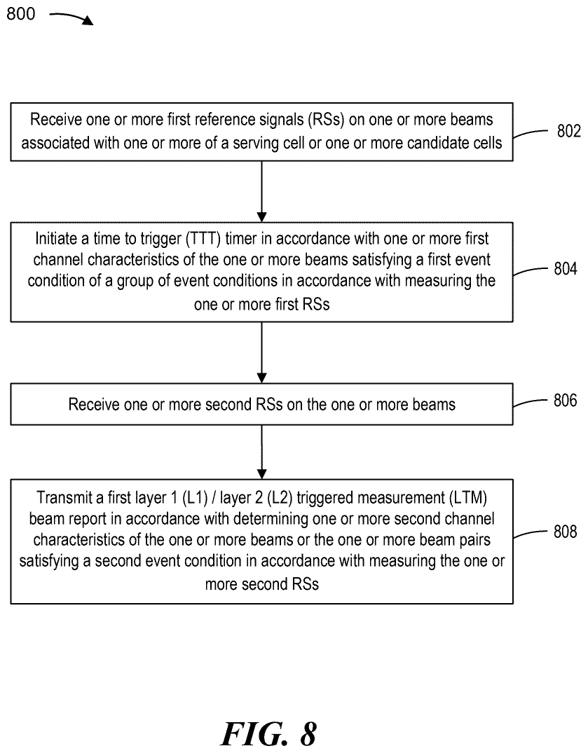

The UEs 120 may include an LTM report module 140. For brevity, only one UE 120d is shown as including the LTM report module 140. The LTM report module 140 may perform one or more operations, such as one or more operations described with respect to the process 800 described with respect to FIG. 8.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

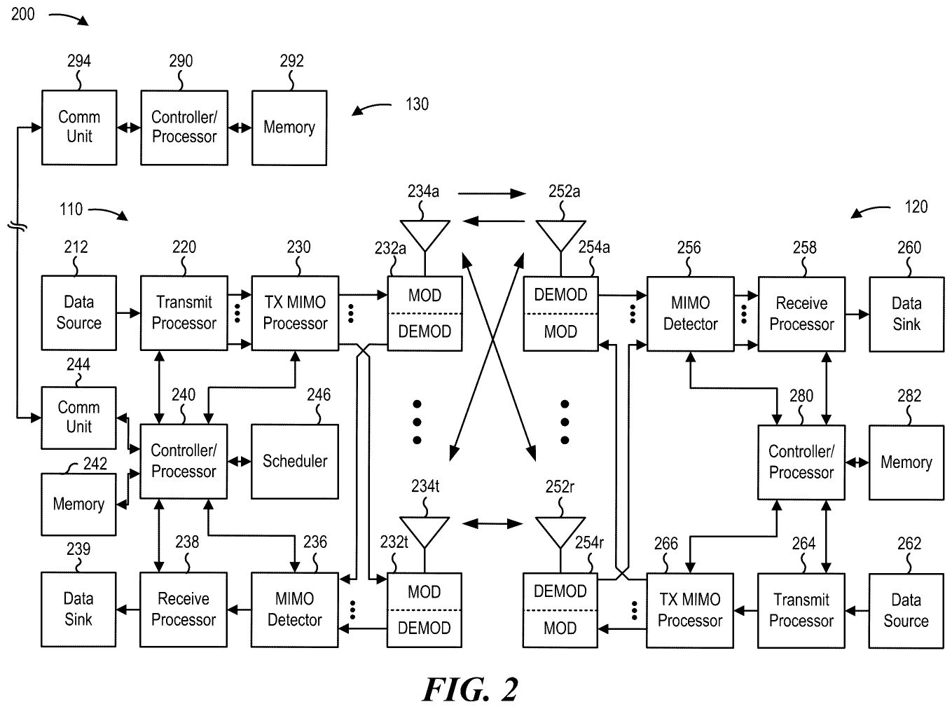

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with triggering an event-driven LTM report as described in more detail elsewhere. For example, the controller/processor 240 of the base station 110, the controller/processor 280 of the UE 120, and/or any other component(s) of FIG. 2 may perform or direct operations of, for example, the processes of FIG. 8 and/or other processes as described. Memories 242 and 282 may store data and program codes for the base station 110 and UE 120, respectively. A scheduler 246 may schedule UEs for data transmission on the downlink and/or uplink.

In some aspects, the UE 120 may include means for receiving, means for receiving one or more first reference signals (RSs) on one or more beams or one or more beam pairs associated with one or more of a serving cell or one or more candidate cells; means for initiating a time to trigger (TTT) timer in accordance with one or more first channel characteristics of the one or more beams or the one or more beam pairs satisfying a first event condition of a group of event conditions in accordance with measuring the one or more first RSs, each one of the group of event conditions associated with one or more of an entering condition or a leaving condition; means for receiving one or more second RSs on the one or more beams or the one or more beam pairs; and means for transmitting a first layer 1 (L1)/layer 2 (L2) triggered measurement (LTM) beam report in accordance with determining one or more second channel characteristics of the one or more beams or the one or more beam pairs satisfying a second event condition in accordance with measuring the one or more second RSs. Such means may include one or more components of the UE 120 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like.

Furthermore, in some cases, a single device may support different applications or services simultaneously.

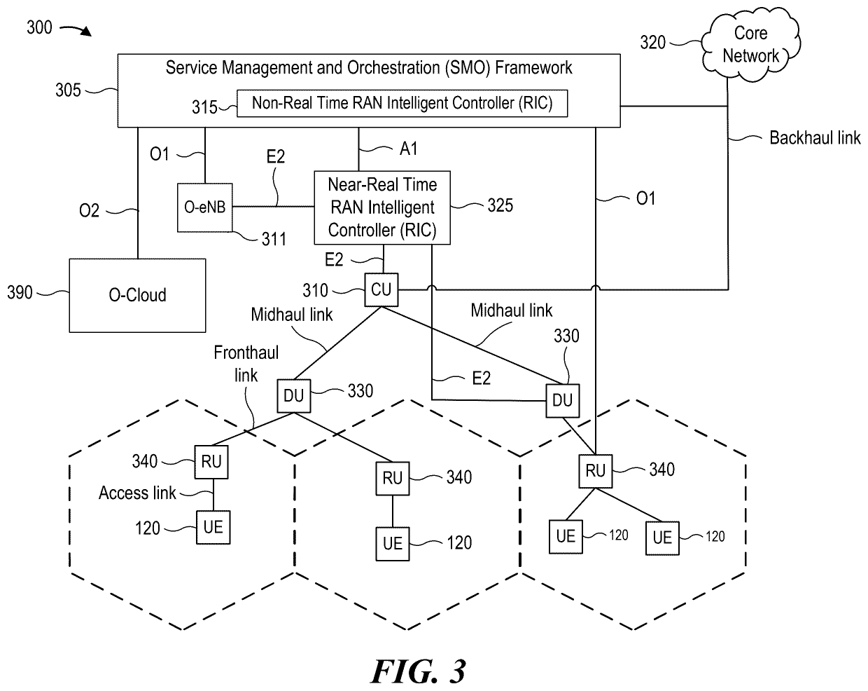

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

In some wireless communication systems, beam reporting may be improved by using a user equipment (UE)-initiated/event-driven mechanism that enables transmission of timely beam reports to a network node (e.g., gNB or base station) with reduced overhead. In such systems, beam management may be improved by reducing a frequency of beam reporting and lowering latency.

Wireless communication standards, such as the 3GPP Standard, include various improvements for event-triggered layer triggered measurement, such as L1 triggered measurements. For example, L1 measurements may be designed to support specific LTM purposes, such as selecting the candidate beam or cell to trigger early synchronization and choosing the target beam or cell for triggering the LTM cell switch procedure. Event-triggered L1 measurements may use beam-level measurement results as the baseline for event evaluation, with further study needed for potential cell-level measurements.

Several LTM events may be supported based on the beam-specific quality of serving and candidate cells as the layer one (L1) measurement events. These events include: (1) Event LTM2: the beam of the serving cell becomes worse than an absolute threshold; (2) Event LTM3: the beam of a candidate cell becomes better by an offset than the beam of the serving cell; (3) Event LTM4: the beam of a candidate cell becomes better than an absolute threshold; and (4) Event LTM5: the beam of the serving cell becomes worse than an absolute threshold, and the beam of the candidate cell becomes better than another absolute threshold. Additional considerations may be specified for beam selection in serving and neighboring cells (e.g., candidate cells) during an event evaluation. Beam configuration for both synchronization signal block (SSB) and channel state information reference signal (CSI-RS) in L1 measurement resources should be supported for both serving and neighboring cells, particularly for Event LTM3 and Event LTM5. Currently, Event LTM1 is not defined.

L1 measurement filtering may be specified. Lastly, for LTM event evaluation, time-to-trigger (TTT), hysteresis for entering/leaving conditions, and beam-specific or cell-specific offsets can be applied to manage measurement reporting after conditions for leaving are met.

For L1 measurement reporting in the serving cell, the current beam, which corresponds to the indicated transmission configuration indicator (TCI) state, may be used for event evaluation. Additionally, any beam within the candidate reference signal (RS) configuration can also be used for event evaluation in LTM.

When evaluating LTM events, the beam-level measurement result, not the cell-level result, is considered as the baseline. As a baseline for 3GPP Release 19, the configuration for LTM event-triggered measurement includes both the LTM measurement resource configuration, which is provided in the LTM-config message, and the event-triggered report configuration, which is defined in the serving cell configuration. Furthermore, the MAC layer is responsible for handling the event evaluation and triggering the measurement report. Finally, event-triggered L1 measurements are reported, by the UE, to the network node via a MAC-CE message.

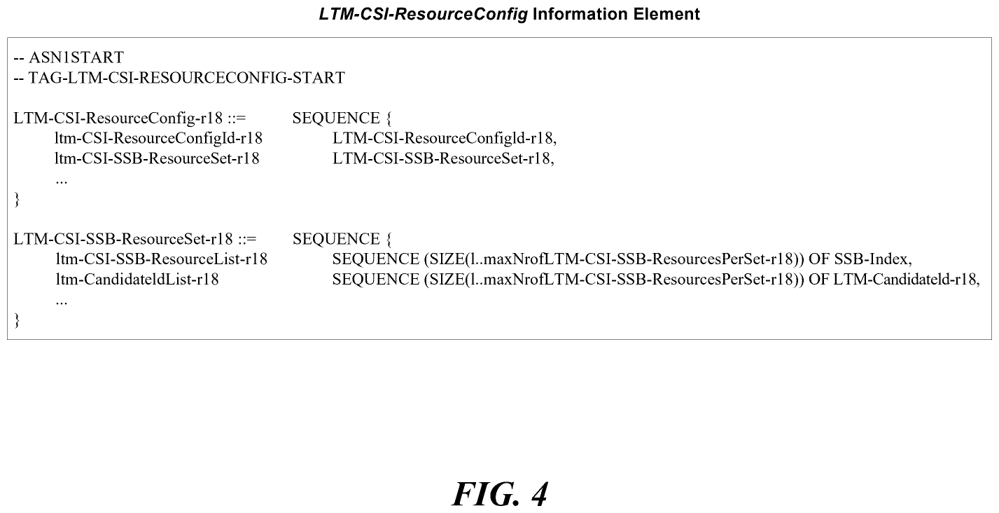

FIG. 4 illustrates an example of an LTM-CSI-SSB-ResourceSet-r18 information element (IE), in accordance with various aspects of the present disclosure. In the example of FIG. 4, the LTM-CSI-SSB-ResourceSet-r18 IE provides two lists: one for SSB indices and another for candidate identifiers (IDs). In an LTM CSI report, the SSB ID or reference signal (RS) ID refers to the ordinal index (rather than the absolute index), which is mapped to these two lists to determine the absolute SSB index and the corresponding candidate cell ID.

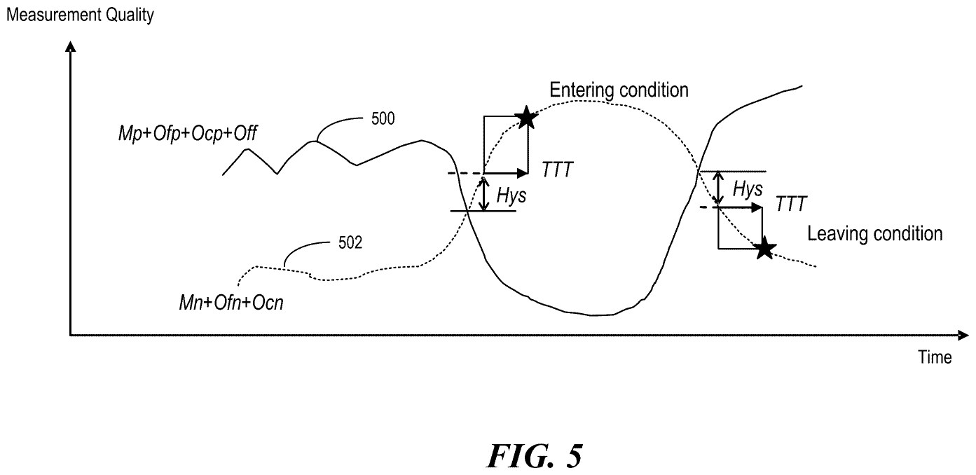

FIG. 5 illustrates an example of a graph for an L3 measurement report (MR) event A3, in accordance with various aspects of the present disclosure. The L3 measurement report event may be used in cellular networks to trigger measurement reports when a signal quality of a neighboring cell 502 becomes better than that of signal quality of a serving cell 500 by a specified offset. The L3 measurement reporting enables a UE to trigger measurement reports when a signal quality of the neighboring cell 502 surpasses or falls below the signal quality of the serving cell 500. By using hysteresis and offsets, the network node may reduce handovers and reporting triggered by minor signal changes, thereby maintaining a stable connection for the UE.

As shown in the example of FIG. 5, an L3 measurement report may be triggered when the signal quality from the neighboring cell 502, adjusted for specific offsets and hysteresis, surpasses the signal quality of the serving cell 500 by the required margin. When this entering condition is satisfied, the UE initiates an L3 measurement report procedure. Conversely, a leaving condition occurs if the signal quality of the neighboring cell 502 weakens or the signal quality of the serving cell 500 strengthens, reversing the initial event trigger. In the example of FIG. 5, the x-axis represents time, and the y-axis represents a measurement quality.

Several parameters may be used to determine entering and/or exiting conditions. The exiting condition may also be referred to as a leaving condition (hereinafter used interchangeably). In the example of FIG. 5, Mn represents a measurement result of the neighbor cell 502, while Mp represents a measurement result of the serving cell 500. The offsets include Ofn and Ofp, which are specific to the reference signals of the neighbor and serving cells 502, 500, respectively. Additionally, Ocn and Ocp represent cell-specific offsets for the neighbor and serving cells 502, 500. Hysteresis (Hys) is introduced to avoid frequent handovers due to small fluctuations in signal strength, while Off represents a general offset parameter for the event.

The entering condition is triggered when a measured signal quality of the neighbor cell 502, adjusted by the offset parameter and hysteresis, becomes better than the measured signal quality of the serving cell 500. The condition is mathematically represented as: (Mn+Ofn+Ocn−Hys>Mp+Ofp+Ocp+Off). More specifically, the entering condition is triggered if the measured signal quality of the neighbor cell 502 is still better than the measured signal quality of the serving cell 500 after a TTT time period has expired.

Similarly, the leaving condition may be satisfied when a measured signal quality of the neighbor cell 502, adjusted by the offset parameter and hysteresis, is less than the measured signal quality of the serving cell 500, represented as: (Mn+Ofn+Ocn+Hys<Mp+Ofp+Ocp+Off). This condition initiates the leaving event if the reportOnLeave flag is set to true and also if the measured signal quality of the neighbor cell 502 is still less than the measured signal quality of the serving cell 500 after the TTT time period has expired.

Various aspects of layer 3 (L3) event-triggered measurement reports, such as hysteresis (HYS), time-to-trigger (TTT), and entering/leaving conditions, are adopted for layer 1 (L1)/layer 2 (L2) triggered measurement (LTM) event-triggered measurement reports. There are, however, differences that must be addressed between L1 measurement reports and L3 measurement reports. In L3, measurement reports are evaluated using a cell-level metric, whereas LTM event-triggered L1 reports are based on a more granular beam-level metric. Accordingly, the entering/leaving conditions and TTT management need to be adapted for individual beams.

Moreover, the MAC-CE format may be specified to support different types of events specific to LTM. Various aspects of this disclosure focus on developing event evaluation methods to manage entering/leaving conditions and TTT for LTM, specifically for UE-initiated or event-driven L1 measurement reporting. This ensures that the reporting mechanisms respond to beam-level changes in the network.

In some examples, for each event, the UE's MAC layer evaluates the measurement results received from a physical (PHY) layer in either a per-beam and per-cell or a per-beam pair and per-cell pair manner. The conditions for entering and leaving an event are maintained consistently. In some examples, the per-beam and per-cell mechanism may be used for events that evaluate a single beam or reference signal (RS), such as Event LTM2 and Event LTM4. In other examples, the per-beam pair and per-cell pair mechanism may be specified for events that compare one beam from the serving cell with another beam from a candidate cell, such as Event LTM3 and Event LTM5.

As previously discussed, the Events are as follows: (1) Event LTM2: the beam of the serving cell becomes worse than the absolute threshold; (2) Event LTM3: the beam of the candidate cell improves by an offset relative to the beam of the serving cell; (3) Event LTM4: the beam of the candidate cell exceeds the absolute threshold; and (4) Event LTM5: the beam of the serving cell becomes worse than the first absolute threshold, and the beam of the candidate cell becomes better than a second absolute threshold.

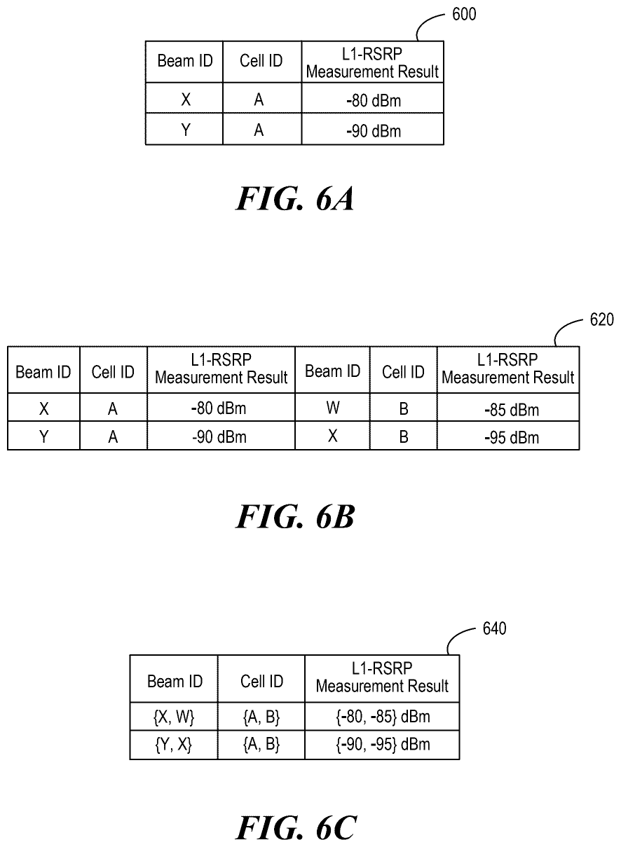

FIG. 6A is a table 600 illustrating an example of per-beam and per-cell measurement evaluations for L1 reference signal received power (L1-RSRP), in accordance with various aspects of the present disclosure. In this example of FIG. 6A, individual beams within a specific cell are evaluated independently. The table 600 shows two beams (X and Y) within a single cell (Cell A). Beam X has an L1-RSRP measurement result of −80 dBm, and beam Y has an L1-RSRP measurement result of −90 dBm. Both measurements are compared against a defined threshold of −100 dBm. As discussed, Events LTM2 and LTM4 are considered for per-beam and per-cell measurement evaluations. These events may specify entering and leaving conditions. In this example, Event LTM4 may be triggered if Cell A is a candidate cell because the L1-RSRP measurement of both beams X and Y are better than the threshold (e.g., −100 dBm).

FIG. 6B is a table 620 illustrating an example of per-beam pair and per-cell pair measurement evaluations for L1 reference signal received power (L1-RSRP), in accordance with various aspects of the present disclosure. In the example of FIG. 6B, a relationship between beams in different cells, specifically serving and candidate cells, is evaluated. The table 620 in FIG. 6B shows L1-RSRP measurements for two beams from the serving cell (X and Y) and two beams from the candidate cell (W and X). Specifically, beam X (Cell A) has an L1-RSRP measurement of −80 dBm, and beam W (Cell B) has an L1-RSRP measurement of −85 dBm. Additionally, beam Y (Cell A) has an L1-RSRP measurement of −90 dBm, and beam X (Cell B) has an L1-RSRP measurement of −95 dBm. Events LTM3 and LTM5 are applicable to the per-beam pair and per-cell pair measurement evaluations. These events may specify entering and leaving conditions.

FIG. 6C is a table 640 illustrating an example of per-beam pair and per-cell pair measurement evaluations for L1 reference signal received power (L1-RSRP), in accordance with various aspects of the present disclosure. In the example of FIG. 6C, a relationship between beams in different cells, specifically serving and candidate cells, is evaluated. The table 640 in FIG. 6C evaluates both beam pairs and their respective cell pairs. That is, beams and cells are combined into pairs. Specifically, the pair of beams X and W from Cells A and B have combined measurement results of −80 dBm and −85 dBm, respectively. Additionally, the pair of beams Y and X from Cells A and B have combined measurement results of −90 dBm and −95 dBm, respectively.

In some examples, when evaluating an event that uses a current beam measurement for the serving cell (e.g., Event LTM2/3/5), the current beam changes due to a transmission configuration indicator (TCI) state update while the time-to-trigger (TTT) is running. Specific behavior of the UE may be predefined in the specifications or signaled through a radio resource control (RRC) parameter as part of the event-specific configuration. In some such cases, the UE stops the TTT and restarts the event evaluation using the newly indicated beam. This approach allows for accurate event reporting based on the new beam. Still, this approach may introduce a delay in the beam report due to the reset of the TTT.

In other examples, the UE keeps the TTT running and evaluates the measurements using the newly indicated beam without restarting the TTT. In this case, the UE behaves as if no TCI state update occurred, treating the current beam as a “virtual beam.” This means that any changes to the beam are considered part of the same virtual beam, minimizing delays in reporting.

In yet other examples, a hybrid approach may be used. In such examples, for events where the current beam is compared against an absolute threshold (e.g., Event LTM2/5), the UE keeps the TTT running and evaluates the measurements using the newly indicated beam without restarting the TTT. However, for events where the current beam is compared to neighbor beams (relative difference), the UE stops the TTT and restarts the event evaluation using the newly indicated beam.

In some examples, a network node may configure, via one or more RRC messages, an event condition at the UE. Specifically, the one or more RRC messages indicate that a beam or beam pair should satisfy the event condition before the UE transmits a beam report. This allows for a more robust evaluation of the signal quality. In some cases, an event is based on multiple beams rather than a single beam, which could reduce false triggers.

In some examples, the network node may configure a specific time window (e.g., timing window) during which the UE monitors multiple beams or beam pairs for the event trigger. The length of this monitoring period can either be configured by the network node or be defined in the specifications. This approach adds flexibility to the beam monitoring process.

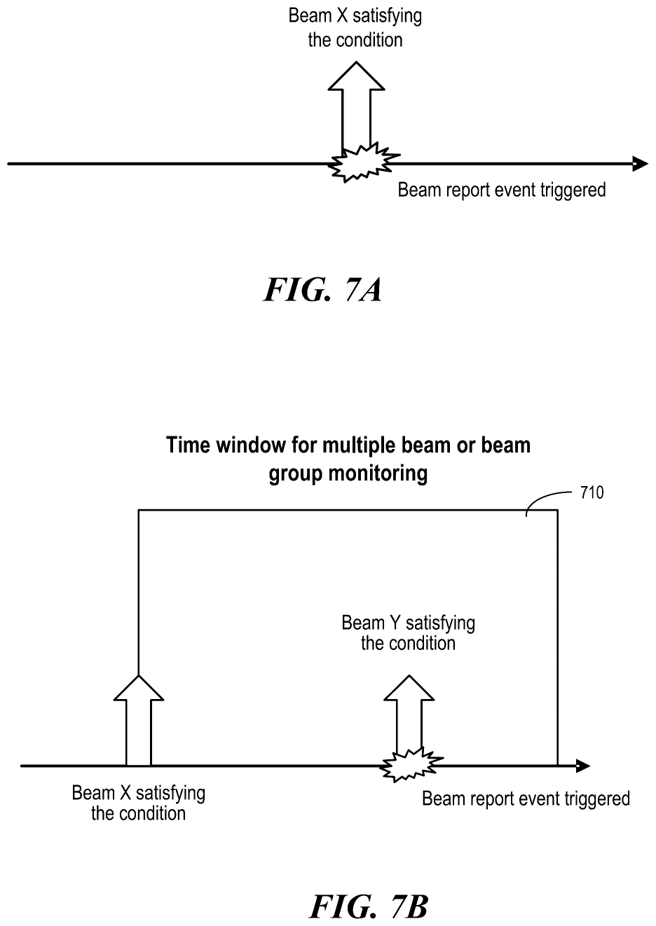

FIG. 7A is a diagram illustrating an example of an event condition triggering a beam report event, in accordance with various aspects of the present disclosure. In the example of FIG. 7A, an event is triggered when a single beam (or beam pair) satisfies the event condition. A process for transmitting a beam report may be initiated in response to the event being triggered. Specifically, as shown in the example of FIG. 7A, a beam X satisfies the event condition, which triggers the beam report event.

FIG. 7B is a diagram illustrating an example of event condition triggering a beam report event, in accordance with various aspects of the present disclosure. In the example of FIG. 7B, a beam report event is triggered based on the measurements of multiple beams or beam pairs. Specifically, a time window 710 may be specified. The time window 710 may also be referred to as a timing window. Once a first beam (e.g., beam X) satisfies an event condition, a beam report event is triggered if a second beam (e.g., beam Y) satisfies the event condition within the time window from the first beam. That is, both beams need to satisfy the condition within the time window 710 for the beam report event to be triggered.

In some examples, a prohibit timer is specified for the UE. Specifically, the UE is not allowed to trigger another event-triggered layer 1 (L1) report for the same event until the prohibit timer expires. This prevents the UE from generating multiple reports in succession for the same event. That is, the use of one or more prohibit timers may reduce redundant reporting and reduce network congestion.

In some such examples, the prohibit timer may be configured per event or per event group in the RRC layer. If configured per event group, multiple events share the same prohibit timer, meaning no events can trigger a report while the prohibit timer is running. Additionally, a priority system can be applied, where higher-priority events can override the timer and trigger a report regardless of its status.

In some examples, the prohibit timer may be managed on one or more levels, such as a per-beam and per-cell level, per-beam pair and per-cell pair level, per-cell level, or per-event level. In the per-beam and per-cell or per-beam pair and per-cell pair level, a report can be triggered if a new beam, different from the one that triggered the original event, satisfies the event condition while the prohibit timer is running. At the per-cell level, a report can be triggered if a beam from a new cell, different from the cell that triggered the original event, satisfies the event condition while the prohibit timer is active. In the per-event level, no report can be triggered until the prohibit timer expires, regardless of any new conditions.

Additionally, the prohibit timer may be overridden if new beam or cell measurements indicate better results than the previous report. For example, if a new beam or cell shows improved measurements, the network node should be notified. Similarly, if the serving beam's measurement has worsened compared to the latest report, the network node should be informed of the degradation in performance.

In some examples, candidate fields may be included in an LTM UE-initiated/event-driven beam report message. These fields may vary depending on the specific event. The candidate fields may provide critical information for event-driven reporting. These fields allow the system to identify and evaluate the current and candidate cell beams for performance monitoring and decision-making. The candidate fields described below may be used in beam reporting for one or more events, however, aspects of the present disclosure are not limited to the candidate fields described below. In some examples, a cell identifier field identifies the serving cell to which the UE is currently connected. The cell identifier field ensures the correct cell is associated with the corresponding beam measurements. An event type field specifies the type of event that triggered the beam reporting, which helps determine the context of the measurements provided by the UE. An event ID field identifies the specific event instance that triggered the report.

The candidate fields may also include serving cell measurement information, which may include one or more fields, such as a current beam ID(s) field that includes the identifiers of the currently active beam(s) in the serving cell, providing information about the primary beam(s) in use. A current beam measurement result(s) field, associated with the current beam(s), indicates measurement results such as signal strength or quality metrics. A number of non-current beams field indicates the number of beams in the serving cell that are not currently active but are still being monitored for potential use. A non-current beam ID(s) field may identify the non-current beams in the serving cell. A non-current beam measurement result(s) field contains the measurement results for the non-current beams, allowing the network to evaluate the quality of beams not currently in use.

The candidate fields may also include candidate cell measurement information, which may include one or more fields, such as a number of candidate beams field that specifies a number of beams in the candidate cell(s) that are being evaluated for potential handover or use. A candidate cell ID(s) (or equivalent ID) field may identify the candidate cell(s), enabling the network to track which cells are being considered for future use. A candidate beam ID(s) field includes IDs of the beams within the candidate cell(s) that are being monitored and reported. An absolute beam ID or ordinal ID field may include beam IDs that are either absolute (directly referencing the beam) or ordinal (referencing a position in a list of beams). A candidate beam measurement result(s) field may include measurement results for the candidate cell beams. An event trigger indicator(s) field signals whether the conditions for triggering the event (such as beam quality thresholds) have been satisfied.

For all events, the cell identifier can be used to identify the serving cell, and the event type can be omitted by referencing the associated event type from the event ID. For Event LTM2, the current beam ID(s) may be used to manage cases where multiple activated TCI states are present. The network node may request the UE to provide beam measurements outside the current beam(s), and the UE may be configured with reference signals for such non-current beam measurements. The field for the number of non-current beams may be omitted if the network node configures this number in the RRC signaling, based on the UE's capabilities for non-current beam measurement and reporting.

For Events LTM3, LTM4, and LTM5, the presence of the current beam ID and its measurement result can be controlled via RRC parameters. Additionally, the network node can request non-current beam measurements using a procedure similar to that of Event LTM2. In some cases, the candidate cell ID can be omitted if it can be derived by looking up the beam (or RS) list and the candidate cell list configured by RRC signaling. This is similar to the process used in Release 18 LTM CSI resource configuration, where two lists (SSB indices and corresponding cell IDs) were provided. In these cases, the SSB resource indicator (SSBRI) in the LTM CSI report is an ordinal index, which can be mapped to these two lists to determine the actual SSB ID and candidate cell ID.

In some examples, a beam report may be reported via a MAC-CE message. Different MAC-CE formats may be specified for LTM UE-initiated/event-driven beam reports. In some examples, a separate MAC-CE format is used for each different event or event group. The specific fields included in the MAC-CE message are determined by the event type, with some fields implicitly assumed to be present or absent based on the context. For example, in Event LTM2, the MAC-CE message may only include the serving cell beam measurement results (for current and/or non-current beams) without including candidate cell beam results. In Event LTM3, the MAC-CE message may include measurements for both the serving and candidate cells, while Event LTM4 only includes candidate cell beam measurement results.

In other examples, a common MAC-CE format covers all events. This common format is capable of handling both serving and candidate cell measurements. In some such examples, a completely flattened structure is specified, meaning the MAC-CE message format is uniform across all serving and candidate cells. This is a per-beam report, hence this structure can be repeated. In the completely flattened structure, the MAC-CE message may include, at least, the following fields: serving or candidate cell identifier (1 bit); beam ID (or RS ID); beam measurement result; and event triggered indicator (1 bit).

In some other examples, two groups may be specified within the MAC-CE message. A first group may be specified for the serving cell and another group for the candidate cells.

In some examples, the beam ID (or RS ID) field can either have a fixed bit width or a variable bit width, depending on the number of beams (or RSs) configured. This is represented as ┌log₂ K┐, where K represents a number of beams or RSs. Additionally, the measurement results may be reported as either an absolute value or a differential value relative to a reference value, which could be the first or the highest measurement value in the set.

In some examples, the MAC-CE-based reporting may be improved by configuring the CSI report associated with the LTM UE-initiated/event-driven beam reports to apply to multiple cells. These multiple cells may include: (i) all configured serving cells, similar to an L3 measurement configuration; or (ii) serving cells within a specific cell group, such as those under the master cell group or secondary cell group. Unlike uplink control information (UCI), which is associated with a specific serving cell, the MAC-CE message does not have any such transmission restrictions. As a result, the MAC-CE message may be transmitted to any serving cell, providing more flexibility in how reports are transmitted across multiple cells.

In some examples, an L1 CSI measurement report configuration information element (csi-MeasConfig) in the RRC message may be applied per cell. Additionally, or alternatively, an L3 measurement report configuration information element (measConfig) in the RRC message may be applied across cells.

Applying CSI report configurations to multiple cells can enhance the flexibility of the reporting mechanism, improving overall network efficiency by allowing MAC-CE reports to be sent to any serving cell without restriction.

FIG. 8 is a flow diagram illustrating an example process 800 performed, for example, by a user equipment (UE), in accordance with various aspects of the present disclosure. The example process 800 is an example of initiating an LTM beam report. As shown in the example of FIG. 8, the process 800 begins at block 802 by receiving one or more first reference signals (RSs) on one or more beams associated with one or more of a serving cell or one or more candidate cells. At block 804, the process initiates a time to trigger (TTT) timer in accordance with one or more first channel characteristics of the one or more beams satisfying a first event condition of a group of event conditions in accordance with measuring the one or more first RSs, each one of the group of event conditions associated with one or more of an entering condition or a leaving condition. At block 806, the process 800 receives one or more second RSs on the one or more beams. At block 808, the process 800 transmits a first layer 1 (L1)/layer 2 (L2) triggered measurement (LTM) beam report in accordance with determining one or more second channel characteristics of the one or more beams satisfying a second event condition in accordance with measuring the one or more second RSs

Implementation examples are described in the following numbered clauses:

Clause 1. An apparatus for wireless communication, at a user equipment, comprising: one or more processors; and one or more memories coupled with the one or more processors and storing processor-executable code that, when executed by the one or more processors, is configured to cause the apparatus to: receive one or more first reference signals (RSs) on one or more beams associated with one or more of a serving cell or one or more candidate cells; initiate a time to trigger (TTT) timer in accordance with one or more first channel characteristics of the one or more beams satisfying a first event condition of a group of event conditions in accordance with measuring the one or more first RSs, each one of the group of event conditions associated with one or more of an entering condition or a leaving condition; receive one or more second RSs on the one or more beams; and transmit a first layer 1 (L1)/layer 2 (L2) triggered measurement (LTM) beam report in accordance with determining one or more second channel characteristics of the one or more beams satisfies a second event condition in accordance with measuring the one or more second RSs.

Clause 2. The apparatus of Clause 1, wherein: a current beam from the serving cell changes to a new beam after the TTT timer is initiated and prior to expiration of the TTT timer; and execution of the processor-executable code further causes the apparatus maintain the TTT timer in accordance with the current beam changing.

Clause 3. The apparatus of any one of Clauses 1-2, wherein the first LTM beam report is transmitted in accordance with the one or more second channel characteristics of the one or more beams satisfying the second event condition during a duration of the timing window.

Clause 4. The apparatus of any one of Clauses 1-3, wherein the first LTM beam report is transmitted after the timing window expires.

Clause 5. The apparatus of any one of Clauses 1-4, wherein: the TTT timer is reset in accordance with the first event condition being associated with an event that compared the current beam to an absolute threshold; and the TTT timer is maintained in accordance with the first event condition being associated with an event that compared the current beam to one or more beams of the one or more candidate cells.

Clause 6. The apparatus of any one of Clauses 1-5, wherein: execution of the processor-executable code further causes the apparatus to initiate a prohibit timer after transmitting the first LTM beam report; the UE refrains from transmitting a second LTM beam report until the prohibit timer expires; and the prohibit timer is associated with one or more of the one or more beams, the one or more beam pairs, one or more cells, one or more cell pairs, a second event, or an event group associated with the first LTM beam report.

Clause 7. The apparatus of any one of Clauses 1-6, wherein the first LTM beam report includes one or more fields including one or more of a cell ID, an event type, an event ID, one or more current beam IDs, one or more current beam measurement results, a number of non-current beams, one or more non-current beam IDs, one or more non-current beam measurement results, a number of candidate beams, one or more candidate beam IDs, one or more candidate beam measurement results, one or more event trigger indicators, a serving cell ID, or a candidate cell ID.

Clause 8. The apparatus of any one of Clauses 1-7, wherein the first LTM beam report is included in a medium access control (MAC)-control element (CE) message.

Clause 9. The apparatus of Clause 8, wherein each event of the group of event conditions is associated with a different MAC-CE message format.

Clause 10. The apparatus of Clause 8, wherein a format of the MAC-CE message is the same for the serving cell and the one or more candidate cells.

Clause 11. The apparatus of Clause 8, wherein the MAC-CE message includes a serving cell report and a candidate cell report.

Clause 13. An apparatus comprising a processor, memory coupled with the processor, and instructions stored in the memory and operable, when executed by the processor to cause the apparatus to perform any one of Clauses 1-12.

Clause 14. An apparatus comprising at least one means for performing any one of Clauses 1-12.

Clause 15. A computer program comprising code for causing an apparatus to perform any one of Clauses 1-12.

The foregoing disclosure provides illustration and description, but is not intended to be exhaustive or to limit the aspects to the precise form disclosed.

Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,”“have,”“having,”and/or the like are intended to be open-ended terms. Further, the phrase “based on” is intended to mean “based, at least in part, on” unless explicitly stated otherwise.

What is claimed is:

1. An apparatus for wireless communication, at a user equipment, comprising:
one or more processors; and
one or more memories coupled with the one or more processors and storing processor-executable code that, when executed by the one or more processors, is configured to cause the apparatus to:
receive one or more first reference signals (RSs) on one or more beams associated with one or more of a serving cell or one or more candidate cells;
initiate a time to trigger (TTT) timer in accordance with one or more first channel characteristics of the one or more beams satisfying a first event condition of a group of event conditions in accordance with measuring the one or more first RSs, each one of the group of event conditions associated with one or more of an entering condition or a leaving condition;
receive one or more second RSs on the one or more beams; and
transmit a first layer 1 (L1)/layer 2 (L2) triggered measurement (LTM) beam report in accordance with determining one or more second channel characteristics of the one or more beams satisfies a second event condition in accordance with measuring the one or more second RSs.

2. The apparatus of claim 1, wherein:
a current beam from the serving cell changes to a new beam after the TTT timer is initiated and prior to expiration of the TTT timer; and
execution of the processor-executable code further causes the apparatus maintain the TTT timer in accordance with the current beam changing.

3. The apparatus of claim 1, wherein the first LTM beam report is transmitted in accordance with the one or more second channel characteristics of the one or more beams satisfying the second event condition during a duration of the timing window.

4. The apparatus of claim 1, wherein the first LTM beam report is transmitted after the timing window expires.

5. The apparatus of claim 1, wherein:
the TTT timer is reset in accordance with the first event condition being associated with an event that compared the current beam to an absolute threshold; and
the TTT timer is maintained in accordance with the first event condition being associated with an event that compared the current beam to one or more beams of the one or more candidate cells.

6. The apparatus of claim 1, wherein:
execution of the processor-executable code further causes the apparatus to initiate a prohibit timer after transmitting the first LTM beam report;
the UE refrains from transmitting a second LTM beam report until the prohibit timer expires; and
the prohibit timer is associated with one or more of the one or more beams, the one or more beam pairs, one or more cells, one or more cell pairs, a second event, or an event group associated with the first LTM beam report.

7. The apparatus of claim 1, wherein the first LTM beam report includes one or more fields including one or more of a cell ID, an event type, an event ID, one or more current beam IDs, one or more current beam measurement results, a number of non-current beams, one or more non-current beam IDs, one or more non-current beam measurement results, a number of candidate beams, one or more candidate beam IDs, one or more candidate beam measurement results, one or more event trigger indicators, a serving cell ID, or a candidate cell ID.

8. The apparatus of claim 1, wherein the first LTM beam report is included in a medium access control (MAC)-control element (CE) message.

9. The apparatus of claim 8, wherein each event of the group of event conditions is associated with a different MAC-CE message format.

10. The apparatus of claim 8, wherein a format of the MAC-CE message is the same for the serving cell and the one or more candidate cells.

11. The apparatus of claim 8, wherein the MAC-CE message includes a serving cell report and a candidate cell report.

12. The apparatus of claim 1, wherein the group of event conditions include:
a first LTM event corresponding to a first channel characteristic of the serving cell being worse than a first channel characteristic threshold;
a second LTM event corresponding to the first channel characteristic of the serving cell being better than the first channel characteristic threshold by at least an offset amount;
a third LTM event corresponding to a second channel characteristic of a first candidate cell of the one or more candidate cells being better than the first channel characteristic threshold; and
a fourth LTM event corresponding to the first channel characteristic of the serving cell being worse than the first channel characteristic threshold and the second channel characteristic of the first candidate cell being better than a second channel characteristic threshold.

13. A method for wireless communication at a user equipment (UE), comprising:
receiving one or more first reference signals (RSs) on one or more beams associated with one or more of a serving cell or one or more candidate cells;
initiating a time to trigger (TTT) timer in accordance with one or more first channel characteristics of the one or more beams satisfying a first event condition of a group of event conditions in accordance with measuring the one or more first RSs, each one of the group of event conditions associated with one or more of an entering condition or a leaving condition;
receiving one or more second RSs on the one or more beams; and
transmitting a first layer 1 (L1)/layer 2 (L2) triggered measurement (LTM) beam report in accordance with determining one or more second channel characteristics of the one or more beams satisfies a second event condition in accordance with measuring the one or more second RSs.

14. The method of claim 13, further comprising:
changing a current beam from the serving cell to a new beam after the TTT timer is initiated and prior to expiration of the TTT timer; and
maintaining the TTT timer in accordance with the current beam changing.

15. The method of claim 13, wherein the first LTM beam report is transmitted in accordance with the one or more second channel characteristics of the one or more beams satisfying the second event condition during a duration of the timing window.

16. The method of claim 13, wherein the first LTM beam report is transmitted after the timing window expires.

17. The method of claim 13, wherein the group of event conditions includes:
a first LTM event corresponding to a first channel characteristic of the serving cell being worse than a first channel characteristic threshold;
a second LTM event corresponding to the first channel characteristic of the serving cell being better than the first channel characteristic threshold by at least an offset amount;
a third LTM event corresponding to a second channel characteristic of a first candidate cell of the one or more candidate cells being better than the first channel characteristic threshold; and
a fourth LTM event corresponding to the first channel characteristic of the serving cell being worse than the first channel characteristic threshold and the second channel characteristic of the first candidate cell being better than a second channel characteristic threshold.

18. A non-transitory computer-readable medium having program code stored thereon, the program code executable by a processor for wireless communication at a user equipment (UE), the program code comprising:
program code to receive one or more first reference signals (RSs) on one or more beams associated with one or more of a serving cell or one or more candidate cells;
program code to initiate a time to trigger (TTT) timer in accordance with one or more first channel characteristics of the one or more beams satisfying a first event condition of a group of event conditions in accordance with measuring the one or more first RSs, each one of the group of event conditions associated with one or more of an entering condition or a leaving condition;
program code to receive one or more second reference signals (RSs) on the one or more beams; and
program code to transmit a first layer 1 (L1)/layer 2 (L2) triggered measurement (LTM) beam report in accordance with determining one or more second channel characteristics of the one or more beams satisfying a second event condition in accordance with measuring the one or more second RSs.

19. The non-transitory computer-readable medium of claim 18, wherein:
a current beam from the serving cell changes to a new beam after the TTT timer is initiated and prior to expiration of the TTT timer; and
the program code further comprises program code to maintain the TTT timer in accordance with the current beam changing.

20. The non-transitory computer-readable medium of claim 18, wherein the first LTM beam report is transmitted in accordance with the one or more second channel characteristics of the one or more beams satisfying the second event condition during a duration of the timing window.
